(19) United States
(12) Patent Application Publication
(10) Pub. No.: US 2020/0357005 A1
(43) Pub. Date: Nov. 12, 2020

(54) BLOCKCHAIN LEDGER-BASED EVIDENCE ACQUISITION METHOD AND SYSTEM

(71) Applicant: ALIBABA GROUP HOLDING LIMITED, George Town (KY)

(72) Inventor: Xinying YANG, Hangzhou (CN)

(21) Appl. No.: 16/938,810

(22) Filed: Jul. 24, 2020

Related U.S. Application Data
(63) Continuation of application No. PCT/CN2019/092635, filed on Jun. 25, 2019.

(30) Foreign Application Priority Data
Aug. 21, 2018 (CN) 201810954378.3

(51) Int. Cl. G06Q 30/00; G06Q 50/26; G06F 16/23; G06F 21/31; G06N 7/00; G10L 17/02; G10L 17/06; G06K 9/00

(52) U.S. Cl. CPC G06Q 30/0185; G06Q 50/265; G06F 16/2315; G06F 21/31; G06K 9/00288; G10L 17/02; G10L 17/06; G06K 9/00268; G06N 7/005

(57) ABSTRACT

Disclosed are a blockchain ledger-based evidence acquisition method and apparatus. A user (party to a lawsuit) can operate user equipment to record one or more of the user's behavior and voice into a multimedia file and then send the multimedia file to a service device, so the service device constructs a target transaction based on the multimedia file and broadcasts the target transaction to a blockchain network for each node in the blockchain network to add the target transaction to the blockchain based on a consensus mechanism. As such, multi-party storage of the multimedia file is realized.

### BACKGROUND

### Technical Field

Implementations of the present specification relate to the field of information technology, and particularly, to a blockchain ledger-based evidence acquisition method and system.

### Description of the Related Art

In judicial practice, for some evidence (such as a witness testimony and a testament) that represents, as an essential element, the true intentions of the parties to a lawsuit, the evidence is sometimes collected on-site by an authority (such as a court or a notary office) in order to obtain decided legal validity for the evidence.

For example, for the witness testimony, in order to prevent the obtained testimony from being tampered with prior to submission to the court, the witness is usually required to give the testimony in person in the court.

For another example, in order to prevent the testament made by a testator from being tampered with prior to submission to the court, which cannot reflect the true intention of the testator, the testament made by the testator can be notarized by a notary on site.

Therefore, there is a need for an evidence acquisition method that is more convenient for the parties.

### BRIEF SUMMARY

In order to solve the problem that an existing evidence acquisition method is not convenient for a party, implementations of the present specification provide a blockchain ledger-based evidence acquisition method and system. The technical solutions include follows.

According to a first aspect of the implementations of the present specification, a blockchain ledger-based evidence acquisition method is provided, including: receiving, by user equipment, an evidence acquisition instruction entered by a user through a target account, the target account being registered on the service device prior to the receiving; recording, by the user equipment, one or more of the user's behavior and voice into a multimedia file in response to the evidence acquisition instruction; sending, by the user equipment, the multimedia file to a service device, the service device being a node in a blockchain network; and constructing, by the service device, a target transaction based on the multimedia file and broadcasting the target transaction to the blockchain network for each node in the blockchain network to add the target transaction to the blockchain based on a consensus mechanism.

According to a second aspect of the implementations of the present specification, a blockchain ledger-based evidence acquisition system is provided. The system includes a blockchain network and user equipment, and any node in the blockchain network is a service device; the user equipment receives an evidence acquisition instruction entered by a user through a target account, the target account being registered on the service device prior to the receiving; records one or more of the user's behavior and voice into a multimedia file in response to the evidence acquisition instruction; and sends the multimedia file to the service device; the service device constructs a target transaction based on the multimedia file and broadcasts the target transaction to the blockchain network; and each node in the blockchain network adds the target transaction to the blockchain based on a consensus mechanism.

According to the technical solutions provided in the implementations of the present specification, a user (party to a lawsuit) can operate user equipment to record one or more of the user's behavior and voice into a multimedia file and then send the multimedia file to a service device, so the service device constructs a target transaction based on the multimedia file and broadcasts the target transaction to a blockchain network for each node in the blockchain network to add the target transaction to the blockchain based on a consensus mechanism. As such, multi-party storage of the multimedia file is realized. In the implementations of the present specification, a party can collect evidence (e.g., a multimedia file) by recording one or more of the user's behavior and voice anytime anywhere without relying on an authority (e.g., a court or a notary office), and the collected evidence can be stored on the blockchain network, so the collected evidence is difficult to tamper with, and can be recognized by the authority and has legal validity.

It should be understood that the general descriptions above and the detailed descriptions below are merely examples and illustrative, and cannot limit the implementations of the present specification.

In addition, any one of the implementations of the present specification does not need to achieve all the effects above.

### BRIEF DESCRIPTION OF THE SEVERAL VIEWS OF THE DRAWINGS

To describe the technical solutions in the implementations of the present specification or in the existing technologies more clearly, the following briefly describes the accompanying drawings needed for describing the implementations or the existing technologies. Clearly, the accompanying drawings in the following descriptions merely show some implementations of the present specification, and a person of ordinary skill in the art can still derive other drawings from these accompanying drawings.

FIG. 1 is a schematic flowchart illustrating a blockchain ledger-based evidence acquisition method according to implementations of the present specification;

FIG. 2 is a schematic structural diagram illustrating a blockchain ledger-based evidence acquisition system according to implementations of the present specification;

FIG. 3 is a schematic structural diagram illustrating a blockchain ledger-based evidence acquisition apparatus according to implementations of the present specification;

FIG. 4 is a schematic structural diagram illustrating another blockchain ledger-based evidence acquisition apparatus according to implementations of the present specification;

FIG. 5 is a schematic structural diagram illustrating a computer device used to configure a method in implementations of the present specification;

FIG. 6 is a diagram illustrating example environments that can be used to execute embodiments of this specification; and

FIG. 7 is a diagram illustrating an example architecture in accordance with embodiments of this specification.

### DETAILED DESCRIPTION

To make a person skilled in the art better understand the technical solutions in the implementations of the present specification, the following describes in detail the technical solutions in the implementations of the present specification with reference to the accompanying drawings in the implementations of the present specification. Clearly, the described implementations are merely some but not all of the implementations of the present specification. All other implementations obtained by a person of ordinary skill in the art based on the implementations of the present specification shall fall within the protection scope of the present specification.

The following describes in detail the implementations of the present specification.

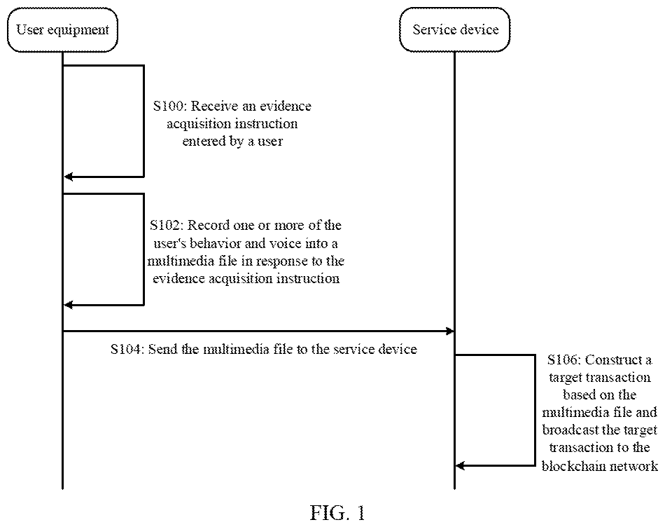

FIG. 1 is a schematic flowchart illustrating a blockchain ledger-based evidence acquisition method according to an implementation of the present specification, and the method includes the following steps:

S100: User equipment receives an evidence acquisition instruction entered by a user.

S102: The user equipment records one or more of the user's behavior and voice into a multimedia file in response to the evidence acquisition instruction.

As described in the background, in judicial practice, for some evidence (such as a witness testimony and a testament) that represents, as an essential element, the true intentions of the parties to a lawsuit, the evidence is sometimes collected on-site by an authority (such as a court or a notary office) in order to obtain decided legal validity for the evidence.

In the implementations of the present specification, the user(s) refers to the above party (parties) to a lawsuit or other legal actions. The user can make a true-intention representation by using the method provided in the implementations of the present specification, to form evidence, e.g., the multimedia file, and the formed evidence can be stored on a blockchain and cannot be tampered with.

The user equipment is the user's device, and can be specifically a mobile phone, a computer, or another device. It should be noted that the user equipment generally is a device having a data processing function, a communications function, and a multimedia information acquisition function. The multimedia information acquisition function of the user equipment is embodied in that the user equipment has elements such as a camera and a recorder.

In the implementations of the present specification, when needing to make a true-intention representation, the user can enter an evidence acquisition instruction to the user equipment to trigger the user equipment to perform evidence acquisition.

Further, the user equipment can receive the evidence acquisition instruction entered by the user through a target account. The target account is registered on a service device prior to the receiving.

It should be noted here that the target account does not necessarily have to be previously registered with the service device by the user, that is, the user does not necessarily have to be the owner of the target account. To that extent, in step S102, after successfully authenticating an identity of the user based on identity authentication information corresponding to the target account, the user equipment records the one or more of the user's behavior and voice into the multimedia file.

The identity authentication information can be a password preset by the owner of the target account, a facial feature or a voiceprint provided in advance, etc.

In the implementations of the present specification, the multimedia file can be specifically any one or more of an audio file, a video file of moving image, a text file, an image file of still image, such as a picture or a graphic interchange format (GIF) picture or may include one or more of an audio component/content, a visual component/content including an image, e.g., still image or moving image, or a text component/content. In the description herein, an image file or an image component is used to indicate either one or both of moving image and still image, unless specifically indicated otherwise.

For example, the user equipment can directly record voice information of the user into an audio file. For another example, the user equipment can first collect voice information of the user, and then convert the voice information into a text file.

In addition, in step S102, before performing recording, the user equipment can detect a recording scene to obtain a recording scene parameter. In some embodiments, the recording scene parameter includes at least one of scene location information, scene environment information, a voice feature of the user, and an expression feature of the user.

It should be noted that the scene location information can be location coordinates of the scene that the user makes an intention representation. The scene environment information can be information such as the brightness of the scene and the space size of the scene. The voice feature of the user can be features such as the tone, the voice speed, and the voice decibel of the user. The expression feature of the user can be an image obtained by taking a still or motion picture of the expression of the user. Various sensors or sensing devices, e.g., an image sensor, an audio sensor, a motion sensor, an environmental sensor or other sensors, may be used by the user equipment to obtain the scene parameters. The sensors may be part of the user equipment or may be electrically or communicatively coupled to the user equipment in obtaining the scene parameters.

Then, the user equipment can send the recording scene parameter(s) to the service device, e.g., a server or a platform, and the service device analyzes the recording scene parameter and obtains, based on the analysis result, a coercion representation value used to represent a probability that the user is in a coerced state. In some embodiments, the coercion representation value is positively related to the probability that the user is in the coerced state.

For a person skilled in the art, it is easy to think of various ways to analyze, based on the recording scene parameter, the probability that the user is coerced. A few examples are given below.

For example, the service device can compare the location information of a device, through which the target account is usually logged into, with the location information of the recording scene. If the two pieces of location information are inconsistent, it indicates that the location, from which the target account is currently logged into, is abnormal, and the user may be coerced to a strange location, or the target account is not logged into by the owner personally.

For example, the service device can determine through analysis that the recording scene is a living room, a basement, or a warehouse based on the brightness and the space size of the recording scene, and if the recording scene is not a living room, it indicates that the user may be coerced.

For example, the service device can determine through analysis whether the voice of the user is stable based on features such as the tone, voice speed, and voice decibel of the user. If the user is coerced, the voice is usually unstable.

For example, the service device can analyze the expression of the user based on the image of the user, and determine whether the user is nervous. If the user is emotionally stressed, the user may be coerced and cannot make a true-intention representation.

In summary, after obtaining the coercion representation value, the service device can determine whether the coercion representation value is less than a specified threshold, e.g., to determine whether the coercion representation value is lower, and if so, it indicates that the user is not likely to be coerced, and can make a true-intention representation in this case. Therefore, the service device notifies the user equipment to record the one or more of the user's behavior and voice into the multimedia file or to generate a multimedia file based on the already recorded behavior or voice of the user.

S104: The user equipment sends the multimedia file to the service device.

S106: The service device constructs a target transaction based on the multimedia file and broadcasts the target transaction to the blockchain network.

After obtaining the multimedia file, the user equipment collects evidence that represents, as an essential element, the true intention of the user, and can send the multimedia file to the service device.

In some embodiments, the service device is also a node in the blockchain network, and the service device can construct the target transaction based on the multimedia file and broadcasts a block containing the target transaction to the blockchain network, so each node in the blockchain network adds the block containing the target transaction to the respective copy of the blockchain based on a consensus mechanism. Upon consensus being concluded, the multimedia file is stored in the blockchain, and is difficult to be tampered with.

It should be noted that the transaction described in the present specification refers to a piece of data that is created by a user by using a blockchain client or by a node of the blockchain network based on a data received from the user and that needs to be finally added to a distributed database of the blockchain, a copy of which is maintained by each nodes of the blockchain network.

Transactions in the blockchain include transactions in a narrow sense and transactions in a broad sense. A transaction in a narrow sense refers to a value transfer added by a user to the blockchain. For example, in a conventional Bitcoin blockchain network, a transaction can be a transfer initiated by a user in the blockchain. A transaction in a broad sense refers to service data that is proposed by a user to the blockchain and that has a service or business intention. For example, an operator can establish a consortium blockchain based on actual service or business needs, and deploy some other types of online services (for example, a rental service, a vehicle scheduling service, an insurance claim service, a credit service, and a medical service) that are not related to value transfer in the consortium blockchain. In such consortium blockchain, a transaction can be a service message or a service request that is provided by a user to the consortium blockchain and that has a service or business intention.

In the implementations of the present specification, the service device can construct the target transaction based on the multimedia file by constructing the target transaction containing the multimedia file. In this case, the multimedia file itself is stored in the blockchain, which requires a high storage capacity of the nodes in the blockchain network.

In addition, the service device can construct the target transaction based on the multimedia file in the following way: on the one hand, the service device stores the multimedia file, and can specifically store the multimedia file locally or in the cloud; on the other hand, the service device can determine a target hash corresponding to the multimedia file based on the multimedia file by using a hash algorithm, and then construct a target transaction including the target hash. The target hash is actually a segment of character string, and the storage space occupied is very small, which does not require a high storage capacity of the nodes in the blockchain network. Moreover, because whether the multimedia file is modified can be detected by using the target hash, storing the target hash into the blockchain is equivalent to realizing multi-party storage of the multimedia file.

Further, the service device can directly use a hash algorithm to calculate a hash value of the multimedia file as the target hash. The service device can also calculate the target hash corresponding to the multimedia file by using the hash algorithm and using the multimedia file and storage location information thereof as input of the hash algorithm.

According to the method in FIG. 1, a user, e.g., a party to a lawsuit or a legal action, can operate user equipment to record one or more of the user's behavior and voice into a multimedia file and then send the multimedia file to a service device, so the service device constructs a target transaction based on the multimedia file and broadcasts the target transaction to a blockchain network, and further each node in the blockchain network adds the target transaction to the blockchain based on a consensus mechanism. As such, multi-party storage of the multimedia file is realized. In the implementations of the present specification, a party can collect evidence, e.g., a multimedia file, by recording one or more of the user's behavior and voice anytime anywhere without relying on an authority (e.g., a court or a notary office), and the collected evidence can be stored on the blockchain network, so the collected evidence is difficult to tamper with, and can be recognized by the authority and has legal validity.

Further, in practice, the user may not be the owner of the target account, and therefore, an intention representation made by the user through the target account may not represent the will of the owner of the target account.

Therefore, in the implementations of the present specification, the producer of one or more of the behavior and the voice recorded in the multimedia file can be identified to determine whether the person is the owner of the target account.

Specifically, the service device can pre-obtain a facial feature (such as the face feature or the iris feature) and a voiceprint feature of the owner of the target account as a trusted facial feature and a trusted voiceprint feature corresponding to the target account. Before the service device broadcasts the target transaction to the blockchain network, in response to that the multimedia file is an audio file, the service device extracts a voiceprint feature of the user from the multimedia file; compares the extracted voiceprint feature with the trusted voiceprint feature; adds a consistency result into the target transaction in response to that the extracted voiceprint feature and the trusted voiceprint feature are consistent with one another; and adds an inconsistency result into the target transaction in response to that the extracted voiceprint feature and the trusted voiceprint feature are inconsistent with one another; in response to that the multimedia file is a video file or an image file, the service device extracts a facial feature of the user from the multimedia file; compares the extracted facial feature with the trusted facial feature; adds a consistency result into the target transaction in response to that the extracted facial feature and the trusted facial feature are consistent with one another; and adds an inconsistency result into the target transaction in response to that the extracted facial feature and the trusted facial feature are inconsistent with one another; or in response to that the multimedia file is an audio and video file, the service device extracts a voiceprint feature and a facial feature of the user from the multimedia file; compares the extracted voiceprint feature with the trusted voiceprint feature; compares the extracted facial feature with the trusted facial feature; adds a consistency result into the target transaction in response to that the extracted voiceprint feature and the trusted voiceprint feature are consistent with one another and the extracted facial feature and the trusted facial feature are consistent with one another; and adds an inconsistency result into the target transaction in response to that the extracted voiceprint feature and the trusted voiceprint feature are inconsistent with one another or the extracted facial feature and the trusted facial feature are inconsistent with one another.

That is, if one or more of the facial feature and the voiceprint feature extracted from the multimedia file are inconsistent with one or more of the facial feature and the voiceprint feature of the owner of the target account, it indicates that the multimedia file does not represent the will of the owner of the target account. Even if the multimedia file is stored in the blockchain, it does not indicate that the multimedia file is a piece of evidence that represents, as an essential element, the intention of the owner of the target account. Therefore, information indicating whether the multimedia file represents the will of the owner of the target account, e.g., a consistency result or an inconsistency result of comparing the facial feature or voiceprint feature extracted from the multimedia file with the trusted facial feature or voiceprint feature, is also included in the target transaction, and then stored in the blockchain for publicity.

Further, if the service device includes an inconsistency result into the target transaction, identity information of the user can be queried based on one or more of the extracted voiceprint feature and the extracted facial feature of the user, and then the identity information of the user is included into the target transaction. This means that if the multimedia file is not produced by the owner of the target account, it indicates that the evidence, e.g., the multimedia file, is forged and the identity information of the user who has forged the evidence is also stored in the blockchain for publicity.

Still further, the credit rating of the user who has forged the evidence can also be adversely affected. For example, in a system for performing credit rating on each user based on the blockchain technique, the credit score corresponding to each user is disclosed in the blockchain. Then, the credit score of the user who has forged the evidence can be deducted, and the deduction record can be stored in the blockchain for publicity.

In addition, in the implementations of the present specification, the service device can add a time stamp of a current time to the target transaction before the service device broadcasts the target transaction to the blockchain network. As such, it is also difficult to tamper with the time at which the multimedia file is stored on the blockchain. In some scenarios, such as a testament scenario, the testator can have made a plurality of testaments before death. Accordingly, a plurality of multimedia files are generated, and are stored on the blockchain by using the method shown in FIG. 1. Then, because the last testament made by the testator is valid according to the inheritance law, the blockchain can be queried to determine the time stamp corresponding to each multimedia file generated by the testator, and determine the multimedia file with the latest time as the latest testament made by the testator, that is, the valid testament.

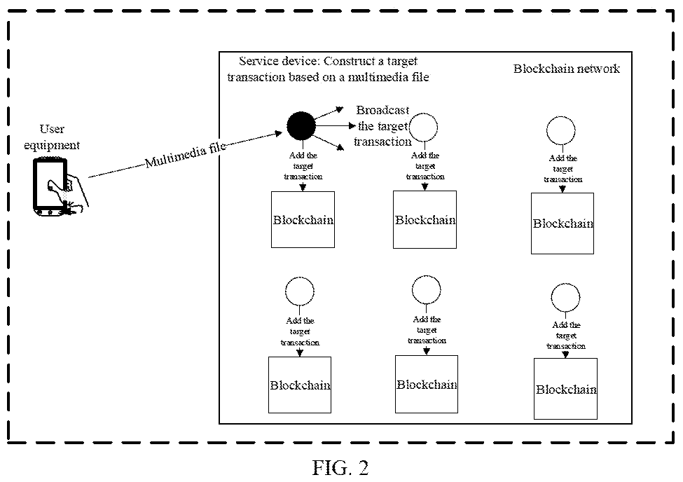

FIG. 2 shows a blockchain ledger-based evidence acquisition system according to implementations of the present specification. The system includes a blockchain network and user equipment, and any node in the blockchain network is a service device. In some embodiments, some of the nodes in the blockchain network may not function as a service device to interact with a user and may not include or assemble a multimedia file into target transaction to be included in a proposed block to broadcast among the nodes of the blockchain system, and may function only as a consensus node to verify and validate a proposed block containing the target transaction and store the validated block containing the target transaction in a copy of the blockchain.

The user equipment receives an evidence acquisition instruction entered by a user; records one or more of the user's behavior and voice into a multimedia file in response to the evidence acquisition instruction; and sends the multimedia file to the service device; the service device constructs a target transaction based on the multimedia file and broadcasts a proposed block containing the target transaction to the blockchain network; and each node in the blockchain network adds the proposed block containing the target transaction to the respective copy of the blockchain based on a consensus mechanism.

As shown in FIG. 2, the solid point is the service device, which is a node in the blockchain network. The hollow point is a node in the blockchain network other than the service device.

Besides the blockchain ledger-based evidence acquisition method shown in FIG. 1, implementations of the present specification further correspondingly provide a blockchain ledger-based evidence acquisition apparatus. As shown in FIG. 3, a service device is a node in a blockchain network, and the apparatus includes: a receiving module 301, configured to receive an evidence acquisition instruction entered by a user; a recording module 302, configured to record one or more of the user's behavior and voice into a multimedia file in response to the evidence acquisition instruction; and a sending module 303, configured to send the multimedia file to the service device, so the service device constructs a target transaction based on the multimedia file and broadcasts a block containing the target transaction to the blockchain network, and further each node in the blockchain network adds the block containing the target transaction to the respective copy of the blockchain based on a consensus mechanism.

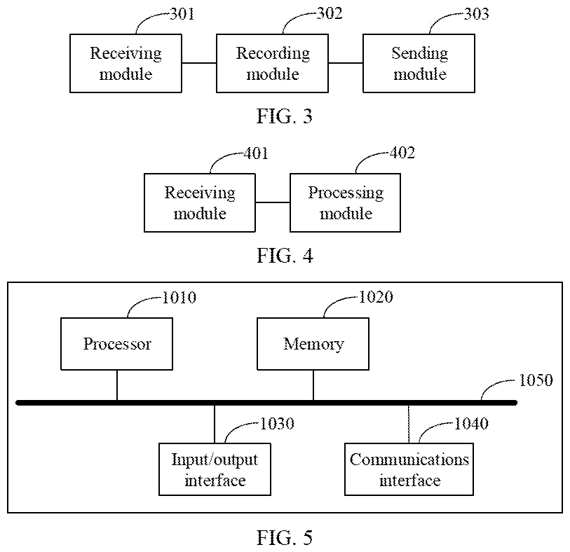

Based on the blockchain ledger-based evidence acquisition method shown in FIG. 1, an implementation of the present specification further correspondingly provides a blockchain ledger-based evidence acquisition apparatus. As shown in FIG. 4, the apparatus is a node in a blockchain network, and the apparatus includes: a receiving module 401, configured to receive a multimedia file sent by user equipment, the multimedia file being obtained by recording one or more of a user's behavior and voice by the user equipment in response to an evidence acquisition instruction after receiving the evidence acquisition instruction entered by the user; and a processing module 402, configured to construct a target transaction based on the multimedia file and broadcast a block containing the target transaction to the blockchain network, so each node in the blockchain network adds the block containing the target transaction to the respective copy of the blockchain based on a consensus mechanism.

An implementation of the present specification further provides a computer device. The computer device includes at least a memory, a processor, and a computer program that is stored in the memory and that can run on the processor. When executing the program, the processor implements the functions of the above user equipment or service device.

FIG. 5 is a more detailed schematic diagram illustrating a hardware structure of a computing device according to an implementation of the present specification. The device can include a processor 1010, a memory 1020, an input/output interface 1030, a communications interface 1040, and a bus 1050. The processor 1010, the memory 1020, the input/output interface 1030, and the communications interface 1040 are communicatively connected to each other inside the device by using the bus 1050.

The processor 1010 can be implemented by using a general central processing unit (CPU), a microprocessor, an application-specific integrated circuit (ASIC), one or more integrated circuits, etc., and is configured to execute a related program, to implement the technical solutions provided in the implementations of the present specification.

The memory 1020 can be implemented by using a read-only memory (ROM), a random access memory (RAM), a static storage device, a dynamic storage device, etc. The memory 1020 can store an operating system and another application program. When the technical solutions provided in the implementations of the present specification are implemented by using software or firmware, related program code is stored in the memory 1020, and is invoked and executed by the processor 1010.

The input/output interface 1030 is configured to be connected to an input/output module, to input or output information. The input/output module (not shown in the figure) can be used as a component and configured in the device, or can be externally connected to the device to provide a corresponding function. The input device can include a keyboard, a mouse, a touchscreen, a microphone, various sensors, etc. The output device can include a monitor, a speaker, a vibrator, an indicator, etc.

The communications interface 1040 is configured to be connected to a communications module (not shown in the figure), to implement a communication interaction between the device and another device. The communications module can perform communication in a wired method (for example, USB or a network cable), or can perform communication in a wireless method (for example, a mobile network, Wi-Fi, or Bluetooth).

The bus 1050 includes one channel, used to transmit information between components (for example, the processor 1010, the memory 1020, the input/output interface 1030, and the communications interface 1040) of the device.

It should be noted that although only the processor 1010, the memory 1020, the input/output interface 1030, the communications interface 1040, and the bus 1050 of the device are shown, during specific implementation, the device can further include other components needed for implementing normal running. In addition, a person skilled in the art can understand that the device can include only components necessary for implementing the solutions in the implementations of the present specification, but does not necessarily include all components shown in the figure.

An implementation of the present specification further provides a computer readable storage medium. The computer readable storage medium stores a computer program. When executing the program, a processor implements the functions of the above user equipment or service device.

The computer readable medium includes persistent, non-persistent, movable, and unmovable media that can store information by using any method or technology. The information can be a computer readable instruction, a data structure, a program module, or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. Based on the definition in the present specification, the computer readable medium does not include transitory media such as a modulated data signal and carrier.

It can be understood from the descriptions of the implementations that, a person skilled in the art can clearly understand that the implementations of the present specification can be implemented by using software and a necessary general hardware platform. Based on such an understanding, the technical solutions in the implementations of the present specification essentially, or the part contributing to the existing technology, can be implemented in a form of a software product. The computer software product can be stored in a storage medium, such as a ROM/RAM, a magnetic disk, or an optical disc, and includes several instructions for instructing a computer device (which can be a personal computer, a server, a network device, etc.) to execute the method described in the implementations of the present specification or in some parts of the implementations of the present specification.

The system, method, module, or unit illustrated in the previous implementations can be implemented by using a computer chip or an entity, or can be implemented by using a product having a certain function. A typical implementation device is a computer in the form of a personal computer, a laptop computer, a cellular phone, a camera phone, a smart phone, a personal digital assistant, a media player, a navigation device, an e-mail transceiver, a game console, a tablet computer, a wearable device, or any combination of at least two of these devices.

The implementations of the present specification are described in a progressive method. For same or similar parts of the implementations, references can be made to the implementations. Each implementation focuses on a difference from other implementations. Particularly, the apparatus and device implementations are similar to the method implementation, and therefore are described briefly. For related parts, references can be made to the descriptions in the method implementation. The method implementation described above is merely an example. The modules described as separate parts can or cannot be physically separate. During implementation of the solutions in the implementations of the present application, functions of the modules can be implemented in one or more pieces of software and hardware. Some or all of the modules can be selected based on an actual need to implement the solutions in the implementations. A person of ordinary skill in the art can understand and implement the implementations of the present application without creative efforts.

To provide further context for embodiments of this specification, and as introduced herein, distributed ledger systems (DLSs) (which can also be referred to as consensus networks, made up of peer-to-peer nodes), and blockchain networks, enable participating entities to securely, and immutably, conduct transactions and store data. Although the term blockchain is generally associated with particular networks, and/or use cases, blockchain is used herein to generally refer to a DLS without reference to any particular use case.

A blockchain is a data structure that stores transactions in a way that the transactions are immutable. Thus, the recording of transactions on a blockchain is reliable and trustworthy. A blockchain includes one or more blocks. Each block in the chain is linked to a previous block immediately before it in the chain by including a cryptographic hash of the previous block. Each block also includes a timestamp, its own cryptographic hash, and one or more transactions. Within a block, the transactions, which have already been verified by the nodes of the blockchain network, are hashed and encoded into a Merkle tree. The Merkle tree is a data structure in which each leaf node includes a hash on a corresponding transaction, and each non-leaf node includes a hash on the concatenation of the hashes in its children. With this process continuing up the tree to the root of the entire tree, the root node includes a hash that is representative of all data in the tree. A hash purporting to be of a transaction stored in the tree can be quickly verified by determining whether it is consistent with the structure of the tree.

Where a blockchain is a decentralized or at least partially decentralized data structure for storing transactions, a blockchain network is a network of computing nodes that manage, update, and maintain one or more blockchains by broadcasting, verifying and validating transactions, etc. As introduced above, a blockchain network can be provided as a public blockchain network, a private blockchain network, or a consortium blockchain network. Embodiments of this specification are described in further detail herein with reference to a consortium blockchain network. However, embodiments of this specification can be realized in any appropriate type of blockchain network.

In general, a consortium blockchain network is private among the participating entities. In a consortium blockchain network, the consensus process is controlled by an authorized set of nodes, referred to as consensus nodes, one or more of which are operated by a respective entity (a financial institution, insurance company, etc.). For example, a consortium of ten (10) entities (financial institutions, insurance companies, etc.) can operate a consortium blockchain network, each of which operates at least one node in the consortium blockchain network.

In some examples, within a consortium blockchain network, a global blockchain is provided as a blockchain that is replicated across all nodes. That is, all consensus nodes are typically in perfect state consensus with respect to the global blockchain. To achieve consensus (agreement to the addition of a block to a blockchain), a consensus protocol or algorithm is implemented within the consortium blockchain network. For example, the consortium blockchain network can implement a practical Byzantine fault tolerance (PBFT) consensus, described in further detail below.

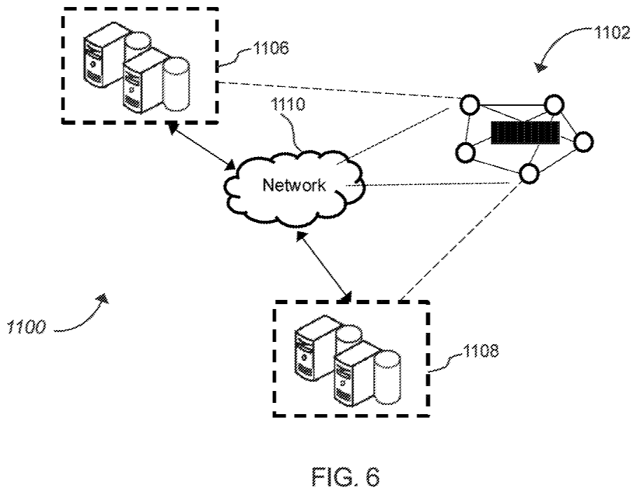

FIG. 6 is a diagram illustrating an example of an environment 1100 that can be used to execute embodiments of this specification. In some examples, the environment 1100 enables entities to participate in a consortium blockchain network 1102. The environment 1100 includes a plurality of computing devices 1106, 1108, and a network 1110. In some examples, the network 1110 includes a local area network (LAN), wide area network (WAN), the Internet, or a combination thereof, and connects web sites, user devices (computing devices), and back-end systems. In some examples, the network 1110 can be accessed over a wired and/or a wireless communications link. In some examples, the network 1110 enables communication with, and within the consortium blockchain network 1102. In general the network 1110 represents one or more communication networks. In some cases, the network 1110 includes network hardware such as switches, routers, repeaters, electrical cables and optical fibers, light emitters and receivers, radio transmitters and receivers, and the like. In some cases, the computing devices 1106, 1108 can be nodes of a cloud computing system (not shown), or each computing device 1106, 1108 can be a separate cloud computing system including a number of computers interconnected by a network and functioning as a distributed processing system.

In the depicted example, the computing systems 1106, 1108 can each include any appropriate computing system that enables participation as a node in the consortium blockchain network 1102. Examples of computing devices include, without limitation, a server, a desktop computer, a laptop computer, a tablet computing device, and a smartphone. In some examples, the computing systems 1106, 1108 host one or more computer-implemented services for interacting with the consortium blockchain network 1102. For example, the computing system 1106 can host computer-implemented services of a first entity (user A), such as a transaction management system that the first entity uses to manage its transactions with one or more other entities (other users). The computing system 1108 can host computer-implemented services of a second entity (user B), such as a transaction management system that the second entity uses to manage its transactions with one or more other entities (other users). In the example of FIG. 6, the consortium blockchain network 1102 is represented as a peer-to-peer network of nodes, and the computing systems 1106, 1108 provide nodes of the first entity and second entity, respectively, which participate in the consortium blockchain network 1102.

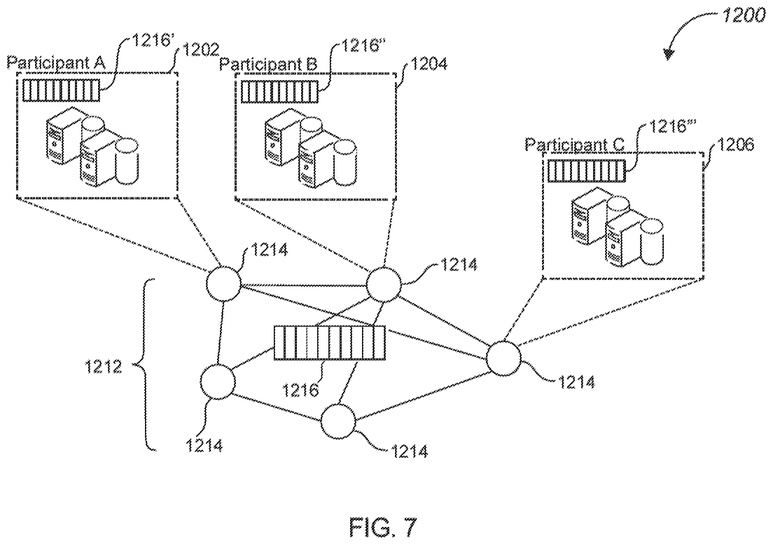

FIG. 7 depicts an example architecture 1200 in accordance with embodiments of this specification. The example architecture 1200 includes participant systems 1202, 1204, 1206 that correspond to Participant A, Participant B, and Participant C, respectively. Each participant (user, enterprise, etc.) participates in a blockchain network 1212 provided as a peer-to-peer network including a plurality of nodes 1214, at least some of which immutably record information in a blockchain 1216. Although a single blockchain 1216 is schematically depicted within the blockchain network 1212, multiple copies of the blockchain 1216 are provided, and are maintained across the blockchain network 1212, as described in further detail herein.

In the depicted example, each participant system 1202, 1204, 1206 is provided by, or on behalf of, Participant A, Participant B, and Participant C, respectively, and functions as a respective node 1214 within the blockchain network 1212. As used herein, a node generally refers to an individual system (computer, server, etc.) that is connected to the blockchain network 1212, and enables a respective participant to participate in the blockchain network. In the example of FIG. 7, a participant corresponds to each node 1214. It is contemplated, however, that a participant can operate multiple nodes 1214 within the blockchain network 1212, and/or multiple participants can share a node 1214. In some examples, the participant systems 1202, 1204, 1206 communicate with, or through, the blockchain network 1212 using a protocol (hypertext transfer protocol secure (HTTPS)), and/or using remote procedure calls (RPCs).

Nodes 1214 can have varying degrees of participation within the blockchain network 1212. For example, some nodes 1214 can participate in the consensus process (as miner nodes that add blocks to the blockchain 1216), while other nodes 1214 do not participate in the consensus process. As another example, some nodes 1214 store a complete copy of the blockchain 1216, while other nodes 1214 only store copies of portions of the blockchain 1216. For example, data access privileges can limit the blockchain data that a respective participant stores within its respective system. In the example of FIG. 2, the participant systems 1202, 1204 store respective, complete copies 1216′, 1216″, 1216′″ of the blockchain 1216. In the descriptions herein, nodes 1214 of the blockchain network 1212 are also referred to as “participant user” for descriptive purposes. In some embodiments, some or all of the participant users 1214 participate in the consensus process and are referred to as “consensus nodes”. The consensus nodes for the blockchain 1216 may also include other nodes not selected from the participant users 1214. In some other embodiments, consensus nodes for adding blocks to the blockchain 1216 do not overlap with the participant users 1214 that propose blocks to be added to the blockchain 1216.

A blockchain, such as the blockchain 1216 of FIG. 7, is made up of a chain of blocks, each block storing data. Examples of data include transaction data representative of a transaction between two or more participants. While transactions are used herein by way of non-limiting example, any appropriate data can be stored in a blockchain (documents, images, video, audio, etc.). Examples of a transaction can include, without limitation, exchanges of something of value (assets, products, services, currency, etc.) or occurrence of some events or activities. The transaction data is immutably stored within the blockchain. That is, an undetectable change cannot be made to the transaction data.

Before being stored in a block, the transaction data is hashed. Hashing is a process of transforming the transaction data, typically provided as string data, into a fixed-length hash value, typically provided as string data. It is not possible to un-hash the hash value to obtain the transaction data. Hashing ensures that even a slight change in the transaction data results in a completely different hash value. Further, and as noted above, the hash value is of a fixed length. That is, no matter the size of the transaction data the length of the hash value is fixed. Hashing includes processing the transaction data through a hash function to generate the hash value. An example of a hash function includes, without limitation, the secure hash algorithm (SHA)-256, which outputs 256-bit hash values.

Transaction data of multiple transactions are hashed and stored in a block. For example, hash values of two transactions are provided, and are themselves hashed to provide another hash. This process is repeated until, for all transactions to be stored in a block, a single hash value is provided. This hash value is referred to as a Merkle root hash, and is stored in a header of the block. A change in any of the transactions will result in change in its hash value, and ultimately, a change in the Merkle root hash.

Blocks are added to the blockchain through a consensus protocol. Multiple nodes within the blockchain network participate in the consensus protocol, and perform work to have a block added to the blockchain. Such nodes are referred to as consensus nodes. PBFT, introduced above, is used as a non-limiting example of a consensus protocol. The consensus nodes execute the consensus protocol to add transactions to the blockchain, and update the overall state of the blockchain network.

In further detail, for example, the consensus node generates a block header, hashes all of the transactions in the block, and combines the hash value in pairs to generate further hash values until a single hash value is provided for all transactions in the block (the Merkle root hash). This Merkle root hash is added to the block header. The consensus node also determines the hash value of the most recent block in the blockchain (the last block added to the blockchain) and adds the hash value of the most recent block into the block header. The consensus node also adds a nonce value, and a timestamp to the block header. The block header is hashed, which becomes the hash value of the block.

In general, PBFT provides a practical Byzantine state machine replication that tolerates Byzantine faults (malfunctioning nodes, malicious nodes, etc.). This is achieved in PBFT by assuming that faults will occur (assuming the existence of independent node failures, and/or manipulated messages sent by consensus nodes). In PBFT, the consensus nodes are provided in a sequence that includes a primary consensus node and backup consensus nodes. The primary consensus node is periodically changed. Transactions are added to the blockchain by all consensus nodes within the blockchain network reaching an agreement as to the world state of the blockchain network. In this process, messages are transmitted between consensus nodes, and each consensus nodes proves that a message is received from a specified peer node and verifies that the message was not modified during transmission.

In PBFT, the consensus protocol is provided in multiple phases with all consensus nodes beginning in the same state. To begin, a client sends a request to the primary consensus node to invoke a service operation (execute a transaction within the blockchain network). In response to receiving the request, the primary consensus node multicasts the request to the backup consensus nodes. The backup consensus nodes execute the request, and each sends a reply to the client. The client waits until a threshold number of replies are received. In some examples, the client waits for f+1 replies to be received, where f is the maximum number of faulty consensus nodes that can be tolerated within the blockchain network. The final result is that a sufficient number of consensus nodes come to an agreement on the order of the record that is to be added to the blockchain, and the record is either accepted, or rejected.

A consensus algorithm refers to a specific mechanism or terms, based on which a transaction or a block is verified and validated to be added into a blockchain. To that extent, a consensus algorithm is viewed as a specific implementation agreement adapted to follow rules of a consensus protocol. Different consensus algorithms may be created for different blockchain networks 1212 or different blockchains 1216, which all comply with a same consensus protocol.

In some blockchain networks, cryptography is implemented to maintain privacy of transactions. For example, if two nodes want to keep a transaction private, such that other nodes in the blockchain network cannot discern details of the transaction, the nodes can encrypt the transaction data. An example of cryptography includes, without limitation, symmetric encryption and asymmetric encryption. Symmetric encryption refers to an encryption process that uses a single key for both encryption (generating ciphertext from plaintext), and decryption (generating plaintext from ciphertext). In symmetric encryption, the same key is available to multiple nodes, so each node can encrypt/decrypt transaction data.

Asymmetric encryption uses keys pairs that each include a private key, and a public key, the private key being known only to a respective node, and the public key being known to any or all other nodes in the blockchain network. A node can use the public key of another node to encrypt data, and the encrypted data can be decrypted using other node's private key. For example, and referring again to FIG. 7, Participant A can use Participant B's public key to encrypt data, and send the encrypted data to Participant B. Participant B can use its private key to decrypt the encrypted data (ciphertext) and extract the original data (plaintext). Messages encrypted with a node's public key can only be decrypted using the node's private key.

Asymmetric encryption is used to provide digital signatures, which enables participants in a transaction to confirm other participants in the transaction, as well as the validity of the transaction. For example, a node can digitally sign a message, and another node can confirm that the message was sent by the node based on the digital signature of Participant A. Digital signatures can also be used to ensure that messages are not tampered with in transit. For example, and again referencing FIG. 7, Participant A is to send a message to Participant B. Participant A generates a hash of the message, and then, using its private key, encrypts the hash to provide a digital signature as the encrypted hash. Participant A appends the digital signature to the message, and sends the message with digital signature to Participant B. Participant B decrypts the digital signature using the public key of Participant A, and extracts the hash. Participant B hashes the message and compares the hashes. If the hashes are same, Participant B can confirm that the message was indeed from Participant A, and was not tampered with.

In some embodiments, a logistics management system can be implemented within the blockchain environment 1100 of FIG. 6 and using the blockchain architecture 1200 of FIG. 7. For example, transaction information of a logistic process is stored as blocks in the blockchain 1216.

The previous descriptions are merely specific implementations of the implementations of the present application. It should be noted that a person of ordinary skill in the art can further make several improvements or polishing without departing from the principles of the implementations of the present specification, and the improvements or polishing shall fall within the protection scope of the implementations of the present specification.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A method, comprising:
receiving, by a service device, a multimedia file containing one or more of a behavior and a voice of a user in relation to an evidence acquisition instruction, the service device being a node in a blockchain network;
constructing, by the service device, a target transaction based on the multimedia file; and
broadcasting the target transaction to the blockchain network for each node in the blockchain network to add the target transaction to a blockchain based on a consensus mechanism.

2. The method of claim 1, further comprising:
receiving, by a user equipment, an evidence acquisition instruction of the user;
recording, by the user equipment, the one or more of the behavior and the voice of the user into the multimedia file in response to the evidence acquisition instruction.

3. The method according to claim 1, wherein the multimedia file includes one or more of an audio file, a video file, a text file, and an image file.

4. The method according to claim 2, wherein,
the receiving the evidence acquisition instruction includes:
receiving the evidence acquisition instruction entered by the user through a target account registered on the service device; and
the recording the one or more of the behavior and the voice of the user into the multimedia file includes:
authenticating an identity of the user based on identity authentication information corresponding to the target account; and
in response to successfully authenticating the identity of the user,
recording the one or more of the behavior and the voice of the user into the multimedia file.

5. The method according to claim 2, wherein the recording the one or more of the behavior and the voice of the user into the multimedia file includes:
detecting, by the user equipment, a recording scene parameter of a scene of the recording;
sending, by the user equipment, the recording scene parameter to the service device;
determining, by the service device, a coercion representation value based on the recording scene parameter, the coercion representation value indicating a probability that the user is in a coerced state;
determining, by the service device, whether the coercion representation value is less than a threshold; and
in response to that the coercion representation value is less than the threshold, notifying, by the service device, the user equipment to record the one or more of the behavior and the voice of the user into the multimedia file.

6. The method according to claim 5, wherein the recording scene parameter includes at least one of scene location information, scene environment information, a voice feature of the user, and an expression feature of the user.

7. The method according to claim 1, wherein the constructing the target transaction based on the multimedia file includes:
constructing the target transaction containing the multimedia file.

8. The method according to claim 1, wherein the constructing the target transaction based on the multimedia file specifically includes:
storing the multimedia file;
obtaining a target hash corresponding to the multimedia file by using a hash algorithm based on the multimedia file; and
constructing the target transaction containing the target hash.

9. The method according to claim 8, wherein the obtaining the target hash includes:
calculating the target hash using the multimedia file and storage location information of the storing the multimedia file as input of the hash algorithm.

10. The method according to claim 2, wherein the receiving the evidence acquisition instruction includes:
receiving, by the user equipment, the evidence acquisition instruction entered by the user through a target account registered on the service device, the target account including a trusted facial feature and a trusted voiceprint feature;
in response to that the multimedia file includes an audio component,
extracting, by the service device, a voiceprint feature of the user from the multimedia file,
comparing the extracted voiceprint feature with the trusted voiceprint feature,
adding a consistency result into the target transaction in response to that the extracted voiceprint feature and the trusted voiceprint feature are consistent with one another, and
adding an inconsistency result into the target transaction in response to that the extracted voiceprint feature and the trusted voiceprint feature are inconsistent with one another;
in response to that the multimedia file includes a visual component,
extracting, by the service device, a facial feature of the user from the multimedia file,
comparing the extracted facial feature with the trusted facial feature,
adding a consistency result into the target transaction in response to that the extracted facial feature and the trusted facial feature are consistent with one another, and
adding an inconsistency result into the target transaction in response to that the extracted facial feature and the trusted facial feature are inconsistent with one another; or
in response to that the multimedia file includes an audio component and a visual component,
extracting, by the service device, a voiceprint feature and a facial feature of the user from the multimedia file;
comparing the extracted voiceprint feature with the trusted voiceprint feature;
comparing the extracted facial feature with the trusted facial feature;
adding a consistency result into the target transaction in response to that the extracted voiceprint feature and the trusted voiceprint feature are consistent with one another and the extracted facial feature and the trusted facial feature are consistent with one another; and
adding an inconsistency result into the target transaction in response to at least one of that the extracted voiceprint feature and the trusted voiceprint feature are inconsistent with one another and that the extracted facial feature and the trusted facial feature are inconsistent with one another.

11. The method according to claim 10, further comprising:
in response to that the service device adds an inconsistency result into the target transaction, obtaining identity information of the user based on one or more of the extracted voiceprint feature and the extracted facial feature of the user; and
adding, by the service device, the identity information of the user into the target transaction.

12. The method according to claim 1, further comprising:
adding, by the service device, a time stamp into the target transaction.

13. A method, comprising:
receiving, by user equipment, an evidence acquisition instruction of a user;
recording one or more of a behavior and a voice of the user into a multimedia file in response to the evidence acquisition instruction; and
sending the multimedia file to a service device, the service device being a node of a blockchain network, for the service device to construct a target transaction based on the multimedia file and broadcast the target transaction to the blockchain network for each node in the blockchain network to add the target transaction to a blockchain based on a consensus mechanism.

14. The method according to claim 13, wherein the recording the one or more of the behavior and the voice of the user into the multimedia file includes:
detecting, by the user equipment, a recording scene parameter of a scene of the recording;
sending, by the user equipment, the recording scene parameter to the service device.

15. The method according to claim 13, wherein,
the receiving the evidence acquisition instruction includes:
receiving, by the user equipment, the evidence acquisition instruction entered by the user through a target account registered on the service device, the target account including a trusted facial feature and a trusted voiceprint feature; and
the constructing, by the service device, the target transaction includes:
extracting at least one of a voiceprint feature and a facial feature of the user from the multimedia file,
comparing each of the at least one of the voiceprint feature and the facial feature with a respective one of the trusted voiceprint feature or the trusted facial feature,
adding a result of the comparing into the target transaction.

16. The method according to claim 13, wherein,
the receiving the evidence acquisition instruction includes:
receiving the evidence acquisition instruction entered by the user through a target account registered on the service device; and
the recording the one or more of the behavior and the voice of the user into the multimedia file includes:
authenticating an identity of the user based on identity authentication information corresponding to the target account; and
in response to successfully authenticating the identity of the user, recording the one or more of the behavior and the voice of the user into the multimedia file.

17. An apparatus, the apparatus being a node in a blockchain network, and the apparatus comprising:
a receiving module, configured to receive a multimedia file sent by a user equipment, the multimedia file containing one or more of a behavior and a voice of a user in relation to an evidence acquisition instruction; and
a processing module, configured to construct a target transaction based on the multimedia file and broadcast the target transaction to the blockchain network for each node in the blockchain network to add the target transaction to a blockchain based on a consensus mechanism.

18. The apparatus according to claim 17, wherein the multimedia file includes a recording scene parameter of a scene where the multimedia file is recorded; and
the processing module is configured to determine a coercion representation value based on the recording scene parameter, the coercion representation value indicating a probability that the user is in a coerced state when the multimedia file is recorded.

19. The apparatus according to claim 17, wherein the processing module is configured to:
store the multimedia file on a storage location; and
construct the target transaction based on the multimedia file by calculating a target hash based on the multimedia file and the storage location.

20. A computer device, comprising a memory and a processor, the memory containing executable instruction, which when executed by the processor configure the processor to implement acts including:
obtaining an evidence acquisition instruction of a user through a target account registered on a service device, the service device being a node of a blockchain network;
recording one or more of the user's behavior and voice into a multimedia file in response to the evidence acquisition instruction; and
sending the multimedia file to the service device for the service device to construct a target transaction based on the multimedia file and broadcast the target transaction to the blockchain network for adding the target transaction into a blockchain based on a consensus mechanism.
